(19) United States
(12) Patent Application Publication
(10) Pub. No.: US 2025/0046549 A1
(43) Pub. Date: Feb. 6, 2025

(54) SWITCHING DEVICE COMPRISING A BELLOWS

(71) Applicant: Siemens Aktiengesellschaft, München (DE)

(72) Inventors: Thomas Heinz, Berlin (DE); Stefan Giere, Falkensee (DE); Michael Bartz, Berlin (DE); Christian Stiehler, Berlin (DE); Klaus Schachtschneider, Berlin (DE); Frank Graskowski, Wandlitz (DE)

(21) Appl. No.: 18/696,482

(22) PCT Filed: Aug. 2, 2022
(86) PCT No.: PCT/EP2022/071696

§ 371 Date: Mar. 28, 2024

(30) Foreign Application Priority Data
Sep. 28, 2021 (DE) 10 2021 210 795.8

(51) Int. Cl. H01H 33/662

(52) U.S. Cl. CPC H01H 33/66238; H01H 33/66207

(57) ABSTRACT

A switching device has at least one bellows made of a low-carbon nickel-chromium-molybdenum-niobium alloy. By using a low-carbon nickel-chromium-molybdenum-niobium alloy as a bellows material in the switching device, the “buckling stiffness”, i.e. the resistance to transverse deflection, and the mechanical service life of the bellows can be increased. The switching device can be a live-tank switching device, a dead-tank switching device, or else a gas-insulated switching device.

The invention relates to a switching device having a bellows made of a low-carbon nickel-chromium-molybdenum-niobium alloy and to the use of such a bellows in a switching device.

Vacuum interrupters are used in low, medium and high voltage switching devices. In the case of a vacuum interrupter (=VSR), the transition from the moving contact rod to the fixed housing of the vacuum interrupter is typically sealed in a vacuum-tight or gas-tight manner by a metal bellows. One end of the metallic bellows is soldered here to the flange of the vacuum interrupter, and the other end is soldered to the moving contact rod. For example, such a bellows 80 is shown in FIG. 3 of DE 10 2017 222 413 A1 (Siemens AG) Jun. 13, 2019.

A bellows is usually designed for several 1000 to a few 1 000 000 switching cycles of the VSR. The service life of the bellows thus influences the service life of the vacuum interrupter. Such a metal bellows ages due to the VSR switching cycles, i.e. the continuously alternating opening and closing of the contacts, which means alternating compression and elongation of the bellows. The highest load on the bellows during a load change occurs here particularly at the ends, or the last corrugations, of the bellows.

Shear forces on the bellows, caused, for example, by poor guiding of the contact rod, the gravity force in a horizontal installation position and the operation of the vacuum interrupter at an increased ambient pressure (>1 bar up to several bar), lead to a transverse deflection of the bellows, which further reduces the service life of the bellows.

One possibility for increasing the service life of the bellows is to mechanically reinforce the bellows by using thicker material. However, the use of thicker bellows material is only possible to a limited extent, as it reduces the necessary flexibility of the bellows. Although a reduced flexibility of the bellows due to the use of thicker material can be at least partially compensated for by an increased number of corrugations, a longer bellows leads to a larger overall length of the VSR, which is undesirable.

It is, therefore, an object of the invention to provide an improved switching device comprising a bellows.

The object is achieved by the features of claim 1. The switching device has at least one bellows made of a low-carbon nickel-chromium-molybdenum-niobium alloy. The switching device can in particular be a medium or high voltage switching device here. The switching device can be a live-tank switching device, a dead-tank switching device, or else a gas-insulated switching device (=GIS), in particular a 1- or 3-phase GIS.

A further achievement of the object is realized by the features of claim 6. Herein, at least one bellows made of a low-carbon nickel-chromium-molybdenum-niobium alloy is used in a switching device. The switching device can in particular be a medium or high voltage switching device here.

By using a low-carbon nickel-chromium-molybdenum-niobium alloy, preferably material number 2.4856/EN Material designation NiCr22Mo9Nb/UNS N06625/Alloy 625, as a bellows material in a switching device, the “buckling stiffness”, i.e. the resistance to transverse deflection, and the mechanical service life of the bellows can be increased. Consequently, in the case of a vacuum-tight or gas-tight application in a switching device, for example, a vacuum-tight or gas-tight cover feedthrough of a moving contact rod, bellows can be used which do not exceed the length of conventional bellows.

The design parameters typically used otherwise, for example the number of corrugations, the corrugation shape, the total corrugation diameter, the corrugation depth (difference in the diameters measured in the corrugation crest and in the corrugation trough), the material used, the wall thickness of the material, the guide of the bellows or the length of the bellows, can also be used when using this material; the effectiveness of the individual design parameters may be weighted/developed differently.

One aspect of the invention is to use a low-carbon nickel-chromium-molybdenum-niobium alloy as the material of a switching device bellows. According to a preferred design embodiment of the invention, the nickel-chromium-molybdenum-niobium alloy with the material number 2.4856/EN material designation NiCr22Mo9Nb/UNS N06625/Alloy 625 is used for this purpose, wherein the material number 2.4856 is composed as follows: 2=material main group “non-ferrous heavy metal”; 48=grade number; 56=numeric designator (EN=European standard; UNS=Unified Numbering System for Metals and Alloys). For example, a low-carbon nickel-chromium-molybdenum-niobium alloy with the material number 2.4856 is marketed under the brand name Inconel®.

A low-carbon nickel-chromium-molybdenum-niobium alloy has significantly greater fatigue strength than a bellows material conventionally used for switching devices. Thus, the invention fundamentally differs from the bellows materials conventionally used for switching devices, nowadays usually stainless steel, in particular stainless steel with the material number 1.4404. This conventionally used stainless steel material is in the material main group 1 “Steels”, whereas the material now proposed according to the invention is now in the material main group 2 “non-ferrous heavy metals”.

An advantage of the invention lies in the use of a special bellows material for achieving a high mechanical service life with the shortest possible length of the bellows, or of a switching device equipped with it. This advantage is particularly relevant at an increased ambient pressure (>1 bar), wherein the bellows made of the low-carbon nickel-chromium-molybdenum-niobium alloy can be used at all operating pressures.

Another aspect of the invention is to use a low-carbon nickel-chromium-molybdenum-niobium alloy in a switching device, for example in a vacuum interrupter and/or in an encapsulation housing.

Studies have shown that a low-carbon nickel-chromium-molybdenum-niobium alloy is very well suited for vacuum applications, especially also for vacuum applications with high pressure differences, due to its special mechanical properties.

Advantageous design embodiments and refinements of the invention are specified in the dependent claims. Here, the device according to the invention may also be refined according to the dependent use claims, and vice versa.

According to a preferred design embodiment of the switching device according to the invention, the nickel-chromium-molybdenum-niobium alloy is the alloy with the material number 2.4856.

According to a preferred design embodiment of the switching device according to the invention, the switching device has a vacuum interrupter with a first bellows made of a low-carbon nickel-chromium-molybdenum-niobium alloy, wherein the first bellows is used for sealing a vacuum of the vacuum interrupter in relation to an ambient pressure of the vacuum interrupter. The bellows can protrude here into the switching chamber of the vacuum interrupter as well as protrude outwards from the housing of the vacuum interrupter. For example, a vacuum of approx. 10-7 bar can be situated in the interior of the switching chamber of the vacuum interrupter and thus on a first side of the bellows, and a fluid (e.g. air or an inert gas such as sulfur hexafluoride) can be under atmospheric pressure or—to increase dielectric strength—under overpressure outside the switching chamber and thus on another side of the bellows; the overpressure can be 3 to 4 bar or even up to 10 bar here. A bellows made of a low-carbon nickel-chromium-molybdenum-niobium alloy has a much longer service life than conventionally used materials, even under these extreme conditions.

According to a preferred design embodiment of the switching device according to the invention, the switching device has an encapsulation housing with a second bellows made of a low-carbon nickel-chromium-molybdenum-niobium alloy, wherein the second bellows is used for sealing a fluid in the encapsulation housing in relation to outside air under atmospheric pressure. The fluid in the encapsulation housing may be, for example, air or inert gas such as sulfur hexafluoride. Here, the bellows can protrude into the interior of the encapsulation housing as well as protrude outwards from the encapsulation housing. For example, in the interior of the encapsulation housing and thus on a first side of the bellows, a fluid may be under atmospheric pressure or under an overpressure of up to 10 bar, and atmospheric pressure may be prevalent outside the encapsulation housing and thus on another side of the bellows.

It is possible here that the encapsulation housing encloses one or a plurality of vacuum interrupters. Here, bellows made of a low-carbon nickel-chromium-molybdenum-niobium alloy can be attached to the encapsulation housing as well as to the one or the plurality of vacuum interrupters. One design embodiment is possible, in which the encapsulation housing encloses a single VSR, wherein the encapsulation housing as well as the VSR each have a single feedthrough with a bellows. Another design embodiment is possible, in which the encapsulation housing encloses a number of N VSRs (N is a natural number), in particular three VSRs, wherein the encapsulation housing has N feedthroughs with a bellows, and the VSRs each have a single feedthrough with a bellows. A further design embodiment is possible, in which the encapsulation housing encloses a number of N VSRs (N is a natural number), in particular three VSRs, wherein the encapsulation housing has a single feedthrough with a bellows, and the movement is transmitted by means of a cross rail within the encapsulation housing to N moving contact rods, wherein the VSRs each have a single feedthrough with a bellows. In all cases, it is possible that the bellows protrude outwards from the housing at the point of the feedthrough through the encapsulation housing and/or the VSR housing, i.e. with the respective external pressure on the outside of the bellows and the respective internal pressure on the inside of the bellows, or extend into the inside of the housing, i.e. with the outside pressure on the inside of the bellows and the inside pressure on the outside of the bellows.

According to a preferred design embodiment of the use according to the invention, a first bellows made of a nickel-chromium-molybdenum-niobium alloy is used for sealing a vacuum of a vacuum interrupter of the switching device in relation to an ambient pressure of the vacuum interrupter. It is possible here that the first bellows is used on a moving contact rod of the vacuum interrupter.

According to a preferred design embodiment of the use according to the invention, a second bellows made of a nickel-chromium-molybdenum-niobium alloy for sealing a fluid, e.g. air or inert gas, is used in an encapsulation housing of the switching device in relation to outside air under atmospheric pressure. In this case, it is possible that the second bellows is used on a moving contact rod of the switching device; for example, the encapsulation housing may have a bearing point of a moving contact rod, at which the opening and closing of the contacts of the switching device leads to a movement, which is to be sealed in a gas-tight manner by means of the second bellows.

According to a preferred design embodiment, the nickel-chromium-molybdenum-niobium alloy is the alloy with the material number 2.4856.

The invention will be explained hereunder by means of exemplary embodiments with the aid of the appended drawing. In the drawings, in each case schematically and not true to scale:

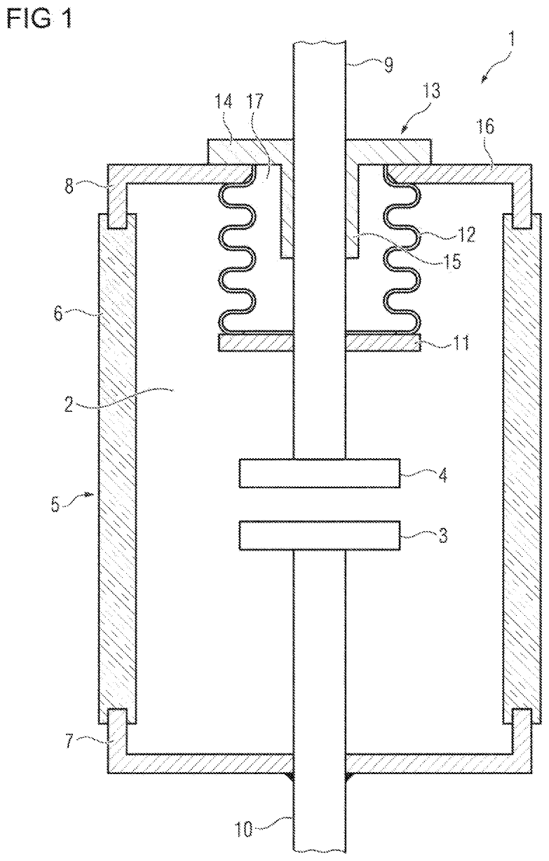

FIG. 1 shows a sectional view of a VSR of a switching device; and

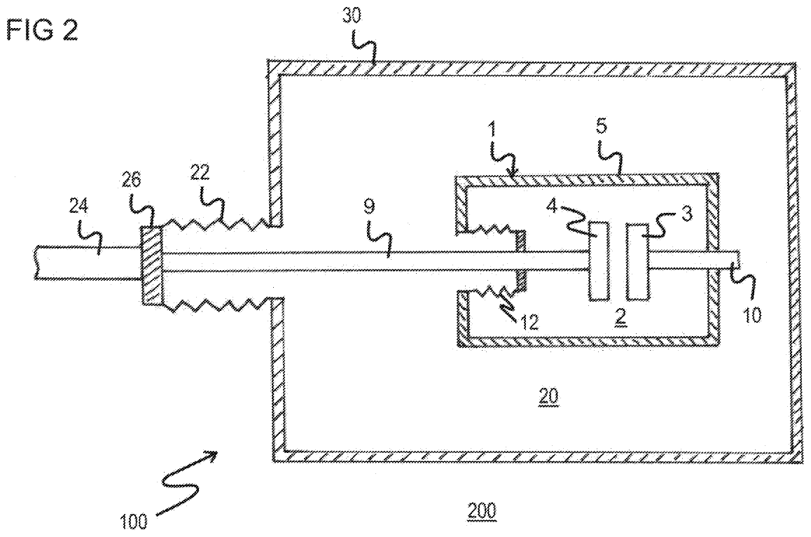

FIG. 2 shows a sectional view of a switching device having a VSR and an encapsulation housing.

FIG. 1 shows a vacuum interrupter 1 with a switching chamber 2 enclosed by a housing 5 in which are disposed a fixed contact 3 and a moving contact 4. The fixed contact 3 is located at one end of a fixed contact rod 10, which is vacuum-tight by a first metallic cover 7, e.g. is routed out of the vacuum interrupter 1 by soldering fixed contact rod 10 and cover 7. The moving contact 4 sits at one end of a moving contact rod 9, which is guided in a displaceable and non-rotatable manner by means of a bearing 13, the latter being fixed to a second cover 8, and is routed out of the vacuum interrupter 1 through the second cover 8. By means of the moving contact rod 9, the moving contact 4 can be brought into contact with the fixed contact 3 in a closing process and moved to a spacing from the fixed contact 3 in an opening process. The covers 7, 8 together with an insulating material cylinder 6 disposed between them, which can be made of ceramic material, form the vacuum-tight housing 5 of the vacuum interrupter 1.

The feedthrough of the moving contact rod 9 through the second cover 8 is kept vacuum-tight by means of a metallic bellows 12 made of a low-carbon nickel-chromium-molybdenum-niobium alloy (material number 2.4856), the first end of which is connected to an internal circumference of a circular through-hole 17 that is arranged in a cover base 16 of the second cover 8, and the second end of which is connected to a projection 11 of the moving contact rod 9 that is referred to as a bellows cap, for example, by soldered connections. The bearing 13 comprises a perforated disk-shaped bearing flange 14 and a tubular guide part 15 which is attached concentrically to the bearing flange 14 and is connected to the latter; the bearing 13 may be made of one piece here. The bearing 13 can be composed of plastics material. The bearing flange 14 is centered on and fixed to the cover base 16, e.g. with the aid of a threaded connection or with the aid of a bearing cap.

The feedthrough of the moving contact rod 9 through the second cover 8 is designed in such a way that the bellows 12 protrudes into the interior of the housing 5 at the location of the feedthrough through the housing 5 of the VSR 1, i.e. with the external pressure of the VSR 1 on the inside of the bellows 12 and the internal pressure of the VSR (vacuum) on the outside of the bellows. Alternatively, a design embodiment is also possible in which the bellows 12 protrudes outwards away from the housing 5 at the location of the feedthrough through the housing 5 of the VSR 1.

FIG. 2 shows a switching device 100 in a so-called dead-tank embodiment. A vacuum interrupter 1 according to FIG. 1 is disposed so as to be electrically isolated from an encapsulation housing 30 which can be embodied as a metallic body. A drive rod 24, which can be actuated by a drive, impinges the moving contact rod 9 via an end plate 26.

There is a vacuum prevalent in the interior of the vacuum interrupter 1, the switching chamber 2. The interior of the encapsulation housing 30, i.e. the intermediate space 20, which is outside the vacuum interrupter 1 and inside the encapsulation housing 30, is filled with an electrically isolating fluid, e.g. air or sulfur hexafluoride; the fluid in the intermediate space 20 can be under atmospheric pressure, or under overpressure, so that the insulation strength of the electrically isolating fluid is additionally improved. Ambient air is situated in the outer space 200 outside the encapsulation housing 30, i.e. atmospheric pressure is prevalent there.

For gas-tight sealing of the evacuated switching chamber 2 in relation to the intermediate space 20, preferably under overpressure, of the encapsulation housing 30, a first bellows 12 is disposed between the moving contact rod 9 and the housing 5 of the vacuum interrupter 1. For gas-tight sealing of the intermediate space 20, preferably under overpressure, of the encapsulation housing 30 in relation to the outer space 200 under atmospheric pressure, a second bellows 22 is disposed between the moving contact rod 9 and the encapsulation housing 30. According to the invention, both metallic bellows 12 and 22 are made here of a low-carbon nickel-chromium-molybdenum-niobium alloy (material number 2.4856).

The feedthrough of the moving contact rod 9 through the housing 5 of the VSR 1 is designed in such a way that the first bellows 12 at the location of the feedthrough through the housing 5 of the VSR 1 protrudes into the interior 2 of the housing 5, i.e. into the switching chamber 2, i.e. with the external pressure of the VSR 1 (=pressure in the intermediate space 20) on the inside of the first bellows 12 and the internal pressure of the VSR (=vacuum in the switching chamber 2) on the outside of the first bellows 12. Alternatively, a design embodiment in which the first bellows 12 at the location of the feedthrough through the housing 5 of the VSR 1 protrudes outwardly away from the housing 5, i.e. into the intermediate space 20, is also possible.

The connection of the moving contact rod 9 to the end piece 26 and thus the feedthrough of the movement of the drive rod 24 through the encapsulation housing 30 is designed in such a way that the second bellows 22 at the location of the feedthrough through the encapsulation housing 30 protrudes outwardly away from the encapsulation housing 30, i.e. into the outer space 200, i.e. with the external pressure of the encapsulation housing 30 (=ambient air under atmospheric pressure) on the outside of the second bellows 22 and the internal pressure of the encapsulation housing 30 (=pressure in the intermediate space 20) on the inside of the second bellows 22. Alternatively, a design embodiment in which the second bellows 22 at the location of the feedthrough through the encapsulation housing 30 protrudes into the interior of the encapsulation housing 30 is also possible.

FIG. 2 is focused on illustrating the arrangement of the spring bellows 12 and 22 and dispenses with details of the electrical contacting of the contact pieces 3 and 4 and of the fastening of the vacuum interrupter 1 in the encapsulation housing 30, since the electrical design embodiment of an electrical switching device in a dead-tank embodiment is known to the person skilled in the art; to this end, reference is made to the relevant explanations in WO2019/197109A1 (Siemens AG) 2019/10/17, for example.

In further design embodiments, metallic bellows 12 and 22 can be used in an analogous manner as in a switching device in a dead-tank embodiment also in switching devices in a live-tank embodiment or in a GIS.

1-11. (canceled)

12. A switching device, comprising:
at least one bellows made from a low-carbon nickel-chromium-molybdenum-niobium alloy.

13. The switching device according to claim 12, wherein said nickel-chromium-molybdenum-niobium alloy is an alloy with a material number 2.4856.

14. The switching device according to claim 12, further comprising a vacuum interrupter with said at least one bellows being a first bellows made of said low-carbon nickel-chromium-molybdenum-niobium alloy, wherein said first bellows is used for sealing a vacuum of said vacuum interrupter in relation to an ambient pressure of said vacuum interrupter.

15. The switching device according to claim 14, further comprising an encapsulation housing with a fluid and a second bellows made of said low-carbon nickel-chromium-molybdenum-niobium alloy, wherein said second bellows is used for sealing said fluid in said encapsulation housing in relation to outside air under atmospheric pressure.

16. The switching device according to claim 15, wherein said encapsulation housing encloses said vacuum interrupter.

17. The switching device according to claim 14, further comprising an encapsulation housing with a fluid and a further bellows made of said low-carbon nickel-chromium-molybdenum-niobium alloy, wherein said further bellows is used for sealing said fluid in said encapsulation housing in relation to outside air under atmospheric pressure.

18. The switching device according to claim 15, further comprising a vacuum interrupter having said at least one bellows, wherein said encapsulation housing encloses said vacuum interrupter.

19. A method of using at least one bellows, which comprises the step of:
providing the at least one bellows made from a low-carbon nickel-chromium-molybdenum-niobium alloy in a switching device.

20. The method according to claim 19, which further comprises using the at least one bellows as a first bellows for sealing a vacuum of a vacuum interrupter of the switching device in relation to an ambient pressure of the vacuum interrupter.

21. The method according to claim 20, wherein the first bellows is used on a moving contact rod of the vacuum interrupter.

22. The method according to claim 20, which further comprises using a second bellows for sealing a fluid in an encapsulation housing of the switching device in relation to outside air under atmospheric pressure.

23. The method according to claim 22, wherein the second bellows is used on a moving contact rod of the switching device.

24. The method according to claim 19, wherein the nickel-chromium-molybdenum-niobium alloy is an alloy with material number 2.4856.
